(19) United States
(12) Patent Application Publication
(10) Pub. No.: US 2015/0188704 A1
(43) Pub. Date: Jul. 2, 2015

(54) DATA COMMUNICATION METHOD AND DATA COMMUNICATION APPARATUS

(71) Applicant: FUJITSU LIMITED, Kawasaki-shi (JP)

(72) Inventors: Masahiko TAKENAKA, Kawasaki (JP); Tetsuya IZU, London (GB); Yumi SAKEMI, Kawasaki (JP)

(21) Appl. No.: 14/582,286

(22) Filed: Dec. 24, 2014

(30) Foreign Application Priority Data
Dec. 27, 2013 (JP) 2013-271364

(51) Int. Cl. H04L 9/08; H04L 9/30; H04L 9/14; H04L 9/32

(52) U.S. Cl. CPC H04L 9/0869; H04L 9/3223; H04L 9/30; H04L 9/14; H04L 2209/24

(57) ABSTRACT

A first random number receiver receives a first encrypted random number from a data communication apparatus. A second random number transmitter decrypts the first encrypted random number using a first private key to obtain a first random number, encrypts a second random number into a second encrypted random number using a second public key, and transmits it to the data communication apparatus. A hash value receiver receives a first hash value from the data communication apparatus. A session key generator generates a second hash value from the first random number decrypted with the first private key and the second random number, and generates a session key based on the first random number and the second random number when the first hash value is equal to the second hash value. In such key sharing communication, a data communication apparatus and another data communication apparatus achieve three-way handshake.

### CROSS-REFERENCE TO RELATED APPLICATION

This application is based upon and claims the benefit of priority of the prior Japanese Patent Application No. 2013-271364, filed on Dec. 27, 2013, the entire contents of which are incorporated herein by reference.

### FIELD

The embodiments discussed herein relate to data communication methods and data communication apparatuses.

### BACKGROUND

There is known a mesh network in which terminals (data communication apparatuses) each having a communication function communicate with each other to form a mesh-like communication network. In communications in the mesh network, data is transmitted from a terminal to the next terminal and to the further next terminal using a bucket relay method, and is finally transmitted to a target terminal. In the mesh network, because an individual terminal just needs to communicate with the next terminal, an alternate route is easily secured even when damage or the like of a terminal occurs. Therefore, the mesh network is said to be robust against failures. Accordingly, the mesh network is expected to be used for the infrastructure in a region where the construction of the communication infrastructure is difficult, and for a sensor network, BEMS/HEMS (Building/Home Energy Management System), and the like.

On the other hand, in the mesh network, because each terminal relays the communication between other terminals, eavesdropping of communication contents is easy at the terminal that relays the communication. Therefore, ensuring the security of communication paths by encryption or the like of the communication is an important issue. Moreover, in the mesh network, because the participation and withdrawal of a terminal in and from the network is easy, terminal authentication is also an important issue in order to prevent addition of an unauthorized terminal. Furthermore, in the sensor network or the like, a terminal might be stolen, the stolen terminal might be analyzed and the internal information would leak. Such cases also need to be taken into consideration.

For example, for constructing a sensor network, there is a proposal that terminal authentication and/or communication path encryption are performed utilizing common key encryption of master key method. In the most fundamental use of this method, all terminals retain the same common key, a master key is securely retained for the purpose of ensuring security, and terminal authentication and communication path encryption are performed using the same key (master key).

Japanese National Publication of International Patent Application No. 2013-503565

Japanese Laid-open Patent Publication No. 11-109854

ZigBee Alliance, “ZigBee Technical Overview”, webpage: docs.zigbee.org/zigbee-docs/dcn/08/docs-08-0127-00-0mwg-zigbee-technical-overview-don-sturek.pdf

W. Du, J. Deng, Y. Han and P. Varshney, “A Pairwise Key Pre-distribution Method for Wireless Sensor Networks,” ACM Conf. CCS, pp. 42-51, 2003

Dan Boneh, Matthew K. Franklin, Identity-Based Encryption from the Weil Pairing Advances in Cryptology—Proceedings of CRYPTO 2001 (2001)

M. Huang “Identity-Based Encryption (IBE) Cipher Suites for Transport Layer Security”, RFC Draft, Jul. 3, 2009

However, in the master key method, when the master key inside a terminal leaks due to theft or the like of the terminal, class break would occur in which the security of the whole network decreases.

In contrast, there is a method (common-key sharing method) in which different keys are shared in advance as common keys between two terminals. The common-key sharing method may prevent the class break, but has a problem that the number of keys to be managed becomes enormous as the number of terminals increases. Moreover, if the information inside a terminal leaks due to theft of the terminal, then with regard to the communication related to the terminal, information about all the communication contents not only at the time point when the internal information leaked and thereafter but also before the time point might leak. This situation is referred to as “non-PFS (Perfect Forward Secrecy)”.

Then, in place of a method, in which a common key is used to ensure the security, the method having a risk of class break and being unable to achieve PFS, the security is ensured by a public key encryption based technique. The examples of the public key encryption based authentication and key sharing protocol include IPsec/IKE (Internet Protocol security/Internet Key Exchange) and SSL/TLS (Secure Sockets Layer/Transport Layer Security). However, IPsec/IKE and SSL/TLS are directed to a terminal or server having a sufficient resource and/or communication environment, and therefore are unsuitable for a terminal constituting a mesh network represented by a sensor network. For example, in the mesh network, in order to perform multihop communication with a terminal not having a sufficient resource, preferably the number of times of key sharing communication (hand shake), in which the public key encryption processing is performed, and/or the communication traffic are small. Moreover, in the mesh network, the number of times of calculation in the public key encryption processing is also preferably small.

However, the conventionally proposed public key encryption based technique needs four or more times of communication for hand shake (four-way hand shake). Moreover, even in the case of three times of communication (three-way hand shake), load of the public key encryption processing and/or communication data volume are large.

### SUMMARY

In one aspect of the embodiments, there is provided a data communication method including: receiving, from another data communication apparatus, a first encrypted random number obtained by encrypting a first random number with a first public key and decrypting the first encrypted random number with a first private key; generating a second random number and transmitting, to the other data communication apparatus, a second encrypted random number obtained by encrypting the second random number with a second public key; receiving, from the other data communication apparatus, a first hash value that is generated from the first random number and the second random number decrypted with a second private key, and comparing a second hash value, which is generated from the first random number decrypted with the first private key and the generated second random number, with the first hash value; and when the second hash value is equal to the first hash value, generating a session key based on the first random number and the second random number.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a data communication method in a data communication apparatus of a first embodiment;

FIG. 2 illustrates an example of a performance comparison table between a key sharing communication method of the first embodiment and conventional methods;

FIG. 3 illustrates an example of the configuration of a sensor network of a second embodiment;

FIG. 4 illustrates an example of the functional configuration of a terminal apparatus of the second embodiment;

FIG. 5 illustrates an example of the hardware configuration of the terminal apparatus of the second embodiment;

FIG. 6 illustrates an example of a key sharing communication sequence between a server side terminal apparatus and a client side terminal apparatus of the second embodiment;

FIG. 7 illustrates an example of the processing performed by the server side terminal apparatus in a hand shake phase of the second embodiment;

FIG. 8 illustrates an example of the processing performed by the client side terminal apparatus in the hand shake phase of the second embodiment;

FIG. 9 illustrates an example of the processing performed by the server side terminal apparatus and the processing performed by the client side terminal apparatus in a data transfer phase of the second embodiment;

FIG. 10 illustrates an example of a data communication method in a data communication apparatus of a third embodiment;

FIG. 11 illustrates an example of a key sharing communication sequence between a server side terminal apparatus and a client side terminal apparatus of a fourth embodiment;

FIG. 12 illustrates an example of the processing performed by the server side terminal apparatus in a hand shake phase of the fourth embodiment;

FIG. 13 illustrates an example of the processing performed by the client side terminal apparatus in the hand shake phase of the fourth embodiment;

FIG. 14 illustrates an example of the processing performed by the server side terminal apparatus and the processing performed by the client side terminal apparatus in a data transfer phase of the fourth embodiment; and

FIG. 15 illustrates an example of a key sharing communication between a server side terminal apparatus and a client side terminal apparatus of a fifth embodiment.

### DESCRIPTION OF EMBODIMENTS

Several embodiments will be described below with reference to the accompanying drawings, wherein like reference numerals refer to like elements throughout.

### First Embodiment

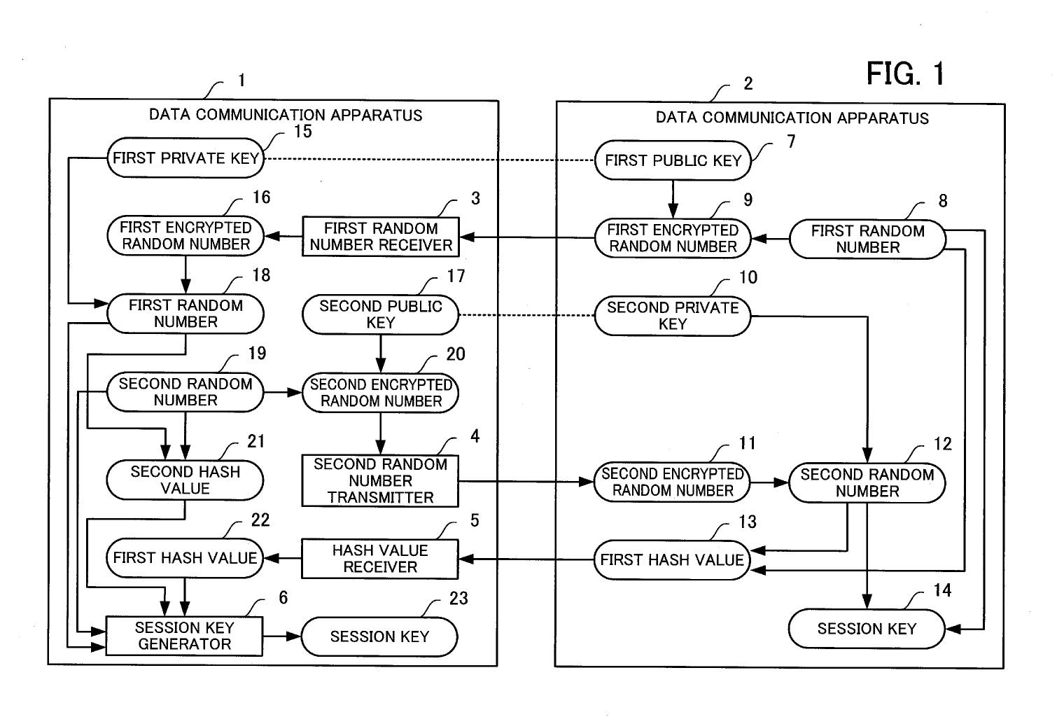

First, a data communication method in a data communication apparatus of a first embodiment is described using FIG. 1. FIG. 1 illustrates an example of the data communication method in the data communication apparatus of the first embodiment.

A data communication apparatus 1 and a data communication apparatus 2 are communicatively connected by wire or wireless to mutually perform data communication. The data communication apparatus 1 and the data communication apparatus 2 may be directly connected, or may be multi-hop connected via one or two or more relay apparatuses. The data communication apparatus 2 is another data communication apparatus for the data communication apparatus 1, and the data communication apparatus 1 is another data communication apparatus for the data communication apparatus 2.

The data communication apparatus 1 includes a first random number receiver 3, a second random number transmitter 4, a hash value receiver 5, and a session key generator 6. The first random number receiver 3 receives a first encrypted random number 16 from the data communication apparatus 2. Note that the first encrypted random number 16 is equal to a first encrypted random number 9 transmitted by the data communication apparatus 2 unless the first encrypted random number 16 is illegally rewritten in the communication path. The data communication apparatus 2 generates a first random number 8, encrypts the first random number 8 into the first encrypted random number 9 using a first public key 7, and transmits the first encrypted random number 9 to the data communication apparatus 1 (corresponding to a non-illustrated first random number transmitter).

The second random number transmitter 4 decrypts the first random number 18 from the first encrypted random number 16 using a first private key 15. The second random number transmitter 4 generates a second random number 19. The second random number transmitter 4 encrypts the second random number 19 into a second encrypted random number 20 using a second public key 17. The second random number transmitter 4 transmits the second encrypted random number 20 to the data communication apparatus 2. Note that the second encrypted random number 11 is equal to the second encrypted random number 20 transmitted by the data communication apparatus 1 unless the second encrypted random number 11 is illegally rewritten in the communication path. The data communication apparatus 2 receives the second encrypted random number 11 (corresponding to a non-illustrated second random number receiver). The data communication apparatus 2 decrypts the second random number 12 using a second private key 10 paired with the second public key 17. The data communication apparatus 2 generates a first hash value 13 from the first random number 8 and the second random number 12. The data communication apparatus 2 transmits the first hash value 13 to the data communication apparatus 1 (corresponding to a non-illustrated hash value transmitter). The data communication apparatus 2 generates a session key 14 from the first random number 8 and the second random number 12.

The hash value receiver 5 receives a first hash value 22 from the data communication apparatus 2. Note that the first hash value 22 is equal to the first hash value 13 transmitted by the data communication apparatus 2 unless the first hash value 22 is illegally rewritten in the communication path.

The session key generator 6 generates a second hash value 21 from the first random number 18 that is decrypted with the first private key 15 paired with the first public key 7 and the second random number 19. The session key generator 6 compares the first hash value 22 with the second hash value 21, and generates a session key 23 based on the first random number 18 and second random number 19 when the first hash value 22 is equal to the second hash value 21. The session key 23 generated by the data communication apparatus 1 matches the session key 14 generated by the data communication apparatus 2 when the first random number 18 matches the first random number 8 and the second random number 19 matches the second random number 12. Note that the data communication apparatus 1 and the data communication apparatus 2 generate the session key using a common session key generation method.

In this manner, the data communication apparatus 1 may retain the session key 23 common with the session key 14 retained by the data communication apparatus 2. In such key sharing communication, the data communication apparatus 1 and the data communication apparatus 2 achieve three times of communication (three-way hand shake). Moreover, since the data communication apparatus 1 receives the first encrypted random number 16 in the first communication and transmits the second encrypted random number 20 in the second communication, the number of pieces of public key encrypted data in three times of communication is “2”. Moreover, the number of times of public key encryption processing is “2” in each of the data communication apparatus 1 and the data communication apparatus 2, and is totally “4” in the data communication apparatus 1 and the data communication apparatus 2. Moreover, in such key sharing communication, the data communication apparatus 1 does not have the risk of class break and achieves PFS. That is, in the method of communicating with the data communication apparatus 2, the data communication apparatus 1 may reduce the network load and processing load in the key sharing communication.

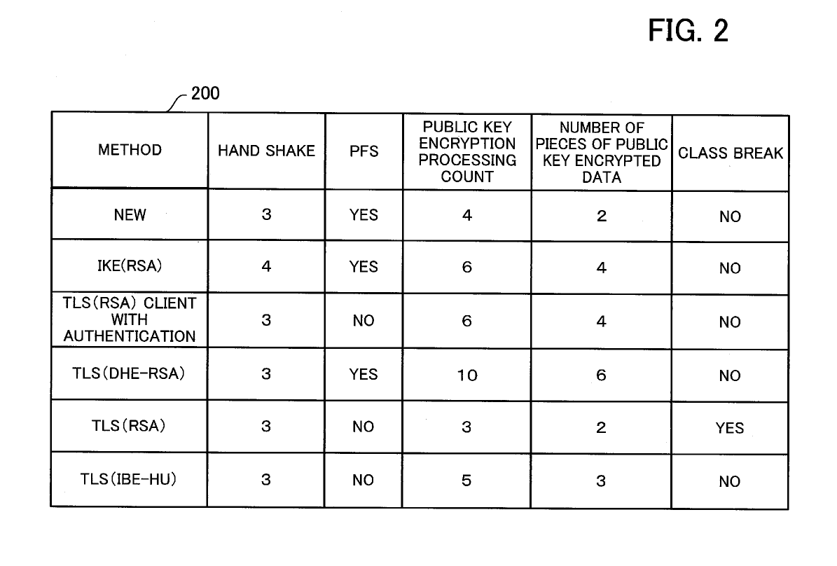

Here, the performance comparison between the key sharing communication method of the first embodiment and the conventional methods is described using FIG. 2. FIG. 2 illustrates an example of the performance comparison table between the key sharing communication method of the first embodiment and the conventional methods.

A performance comparison table 200 comparably illustrates the performance of the key sharing communication method of the first embodiment and the performances of the conventional methods. In the performance comparison table 200, the key sharing communication method of the first embodiment and the conventional methods are arranged in the vertical direction while the performance values of each method are arranged in the horizontal direction. “New” indicates the key sharing communication method of the first embodiment. The conventional methods include “IKE(RSA)”, “TLS(RSA) with client authentication”, “TLS (DHE-RSA)”, “TLS (RSA)”, and “TLS (IBE-HU)”.

Performance evaluation items are hand shake, PFS, public key encryption processing count, number of pieces of public key encrypted data, and class break. The hand shake indicates the number of times of key sharing communication, PFS indicates whether or not there is PFS, the public key encryption processing count indicates the number of times of public key encryption processing, the number of pieces of public key encrypted data indicates the number of pieces of public key encrypted data transmitted and received, and the class break indicates whether or not there is the risk of class break.

According to this table, in “New”, the hand shake is “3”, which is the minimum as compared with other conventional methods. This hand shake “3” is the theoretically minimal value. Moreover, in “New”, the public key encryption processing count is “4”, which is sufficiently small as compared with other conventional methods. Moreover, in “New”, the number of pieces of public key encrypted data is “2”, which is sufficiently small as compared with other conventional methods. As described above, in “New”, the network load and processing load in the key sharing communication are small as compared with other conventional methods. Note that, in “TLS (RSA)”, the hand shake is “3”, the public key encryption processing count is “3”, and the number of pieces of public key encrypted data is “2”. Therefore, “TLS (RSA)” is superior to “New” in terms of numeric data, and does not have risk of class break. However, “TLS (RSA)” fails to achieve PFS. In contrast, “New” does not have the risk of class break and further achieves PFS. Such a key sharing communication method is not found in the conventional methods.

### Second Embodiment

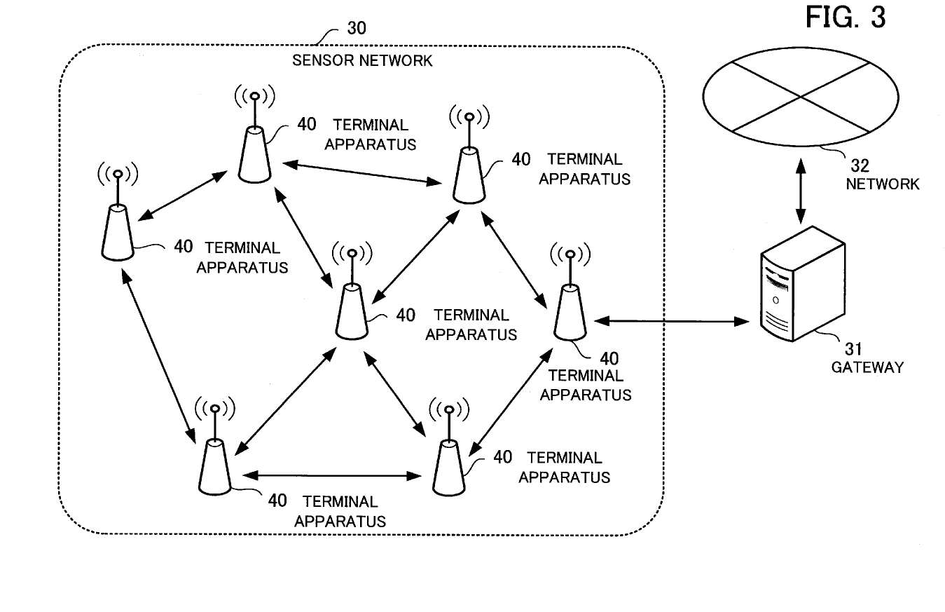

Next, a second embodiment is described in which the key sharing communication method of the first embodiment is applied to a sensor network. First, the sensor network of the second embodiment is described using FIG. 3. FIG. 3 illustrates an example of the configuration of the sensor network of the second embodiment.

A sensor network 30 includes a plurality of terminal apparatuses 40. The terminal apparatus 40 is communicatively connected to one or more other terminal apparatuses 40. The sensor network 30 is, for example, a mesh network in which two of the terminal apparatuses 40 are connected through multi-hop communication.

In the sensor network 30, one or more terminal apparatuses 40 connect to a gateway 31, and connect to a network 32 (e.g., Internet) via the gateway 31.

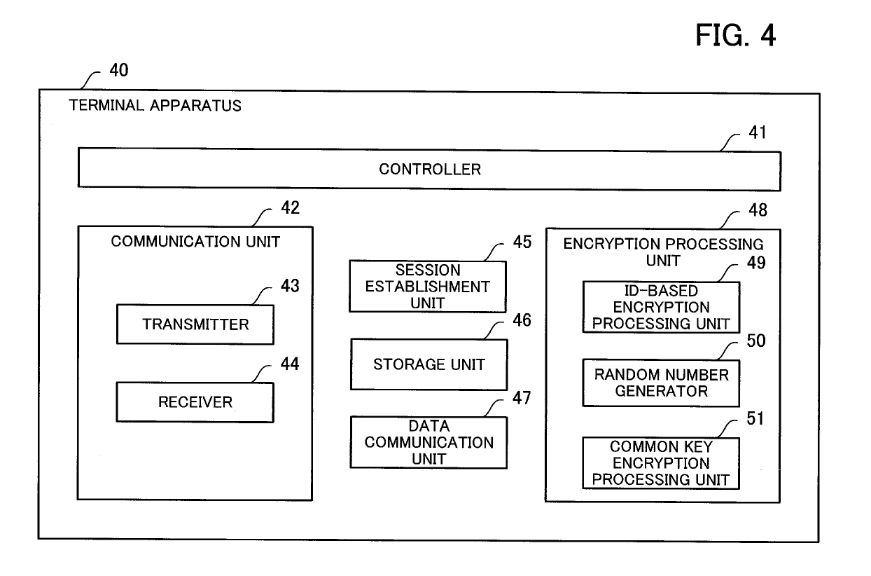

Next, the functional configuration of the terminal apparatus 40 is described using FIG. 4. FIG. 4 illustrates an example of the functional configuration of the terminal apparatus of the second embodiment.

The terminal apparatus 40 includes a controller 41, a communication unit 42, a session establishment unit 45, a storage unit 46, a data communication unit 47, and an encryption processing unit 48. The controller 41 totally controls the terminal apparatus 40. The communication unit 42 is an interface for communicating with another terminal apparatus 40. The communication unit 42 includes a transmitter 43 and a receiver 44, transmits data to another terminal apparatus 40 via the transmitter 43, and receives data from another terminal apparatus 40 via the receiver 44.

The session establishment unit 45 establishes a session with another terminal apparatus 40. The session establishment unit 45 controls the communication in a hand shake phase. The storage unit 46 stores needed information, such as the information used for session establishment and the information used for data communication. The data communication unit 47 controls the data communication in a data transfer phase after establishing a session with another terminal apparatus 40.

The encryption processing unit 48 performs the processing related to encryption. The encryption processing unit 48 includes an ID-based encryption processing unit 49, a random number generator 50, and a common key encryption processing unit 51. The ID-based encryption processing unit 49 executes ID-based encryption processing. In the hand shake phase, the ID-based encryption processing unit 49 encrypts the data to be encrypted, with the ID (IDentification) of another terminal apparatus 40 as the public key, and decrypts the data to be decrypted, with a private key paired with the own ID. The ID is identification information for uniquely identifying the terminal apparatus 40. The ID is, for example, the name, number, or address specific to the terminal apparatus 40 or a combination of these. The random number generator 50 generates a random number using a predetermined random number generation algorithm. In the data transfer phase, the common key encryption processing unit 51 encrypts the data to be encrypted and decrypts the data to be decrypted using a common key (session key) common between the own terminal apparatus 40 and another terminal apparatus 40.

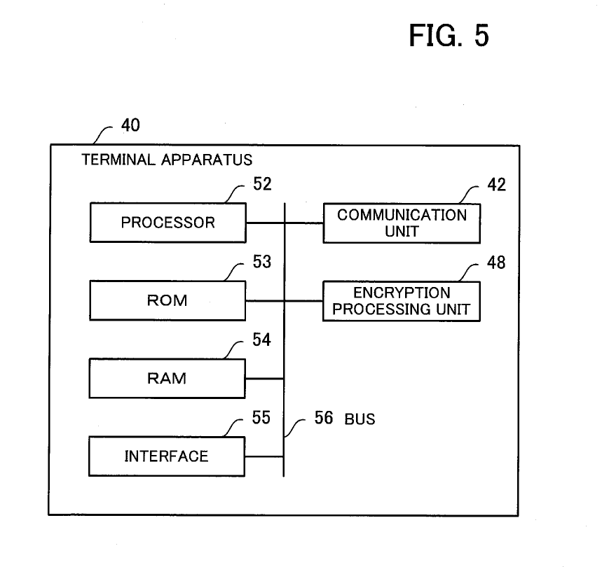

Next, the hardware configuration of the terminal apparatus 40 is described using FIG. 5. FIG. 5 illustrates an example of the hardware configuration of the terminal apparatus of the second embodiment.

The whole terminal apparatus 40 is controlled by a processor 52. A ROM (Read Only Memory) 53, a RAM (Random Access Memory) 54, an interface 55, and a plurality of peripheral devices are connected to the processor 52 via a bus 56. The processor 52 may be a multiprocessor. The processor 52 may be, for example, a CPU (Central Processing Unit), an MPU (Micro Processing Unit), a DSP (Digital Signal Processor), an ASIC (Application Specific Integrated Circuit), or a PLD (Programmable Logic Device). Moreover, the processor 52 may be a combination of two or more of the CPU, MPU, DSP, ASIC, and PLD.

The ROM 53 retains the memory content even when the terminal apparatus 40 is in power-off state. The ROM 53 is, for example, a semiconductor memory device, such as an EEPROM (Electrically Erasable Programmable Read-Only Memory) or a flash memory, or an HDD (Hard Disk Drive). Moreover, the ROM 53 is used as the auxiliary storage device of the terminal apparatus 40. The program or firmware of an OS (Operating System), application programs, and various types of data are stored in the ROM 53.

The RAM 54 is used as the main storage device of the terminal apparatus 40. At least a part of the program or firmware of OS, and application programs executed by the processor 52 are temporarily stored in the RAM 54. Moreover, various types of data needed for the processing by the processor 52 are stored in the RAM 54. Moreover, the RAM 54 may include a cache memory separate from a memory that is used for storing various types of data. The peripheral devices connected to the bus 56 include the interface 55, the communication unit 42, and the encryption processing unit 48. The interface 55 connects to an input/output device and performs input and output processing.

With such a hardware configuration described above, the processing functions of the terminal apparatus 40 of the second embodiment may be realized. Note that the data communication apparatuses 1 and 2 illustrated in the first embodiment may be also realized with the hardware similar to the hardware of the terminal apparatus 40 illustrated in FIG. 5. Moreover, data communication apparatuses 101 and 102 to be illustrated in a third embodiment, a terminal apparatus to be illustrated as a fourth embodiment, and a terminal apparatus to be illustrated as a fifth embodiment may be also realized with hardware similar to the hardware of the terminal apparatus 40 illustrated in FIG. 5.

The terminal apparatus 40 realizes the processing functions of the embodiment by executing the programs stored on a computer-readable storage medium, for example. The program describing processing contents to be executed by the terminal apparatus 40 may be stored on various storage media. For example, the programs to be executed by the terminal apparatus 40 may be stored in the ROM 53. The processor 52 loads at least a part of the programs inside the ROM 53 into the RAM 54, and executes the loaded programs. Moreover, the programs to be executed by the terminal apparatus 40 may be stored on portable storage media, such as a non-illustrated optical disc, memory device, and memory card. The examples of the optical disc include a DVD (Digital Versatile Disc), a DVD-RAM, a CD-ROM (Compact Disc-Read Only Memory), and a CD-R (Recordable)/RW (ReWritable). The memory device is a storage medium having a function to communicate with the interface 55 or with a non-illustrated device connection interface. For example, the memory device may write data to a memory card or read data from a memory card using a memory reader and writer. The memory card is a card-type storage medium.

A program stored on a portable storage medium is installed on the ROM 53 under the control of the processor 52 and then becomes executable. Moreover, the processor 52 may read the program directly from the portable storage medium and execute the same.

Note that, the data communication apparatuses 1 and 2 illustrated in the first embodiment, the data communication apparatuses 101 and 102 illustrated in the third embodiment, and a terminal apparatus to be illustrated as the fourth embodiment or fifth embodiment also realize the processing functions of the embodiment by executing the programs as with the terminal apparatus 40 illustrated in FIG. 5.

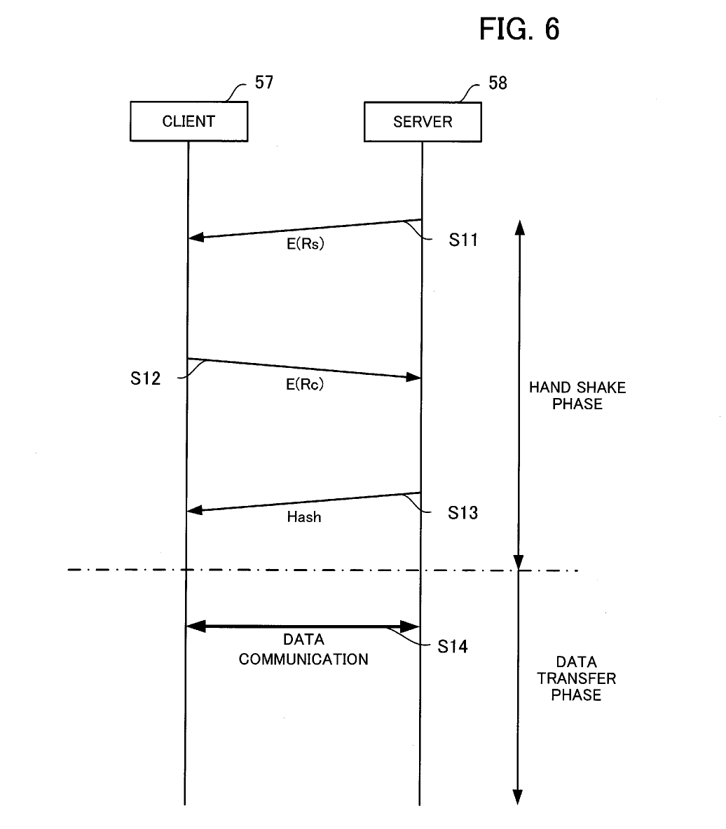

Next, the key sharing communication sequence between a server side terminal apparatus and a client side terminal apparatus of the second embodiment is described using FIG. 6. FIG. 6 illustrates an example of the key sharing communication sequence between the server side terminal apparatus and client side terminal apparatus of the second embodiment.

One of the two terminal apparatuses 40 is a client (client side terminal apparatus) 57, and the other one is a server (server side terminal apparatus) 58.

In the key sharing communication sequence between the server side terminal apparatus and the client side terminal apparatus of the second embodiment, the server 58 starts communication because the client 57 does not need to send a certificate to the server 58.

(Step S11) The server 58 transmits to the client 57 an encrypted random number E(Rs) obtained by encrypting a random number Rs with an ID-based public key of the client 57. The random number Rs is a random number generated by the server 58.

(Step S12) The client 57 transmits to the server 58 an encrypted random number E(Rc) obtained by encrypting a random number Rc with an ID-based public key of the server 58. The random number Rc is a random number generated by the client 57.

(Step S13) The server 58 decrypts the encrypted random number E(Rc) with a private key of the server 58, and transmits to the client 57 a hash value (Hash) generated from the decrypted random number Rc and the random number Rs.

The client 57 decrypts the encrypted random number E(Rs) with a private key of the client 57, compares a hash value generated from the decrypted random number Rs and the random number Rc with a hash value received from the server 58, and establishes a session when two hash values match.

The above-described step S11 to step S13 correspond to the hand shake phase including three times of key sharing communication. Hereinafter, the client 57 and the server 58 perform data communication using a session key generated from the random number Rc and a session key generated from the random number Rs, respectively (step S14). The step S14 and thereafter correspond to the data transfer phase in which the protected data communication is possible.

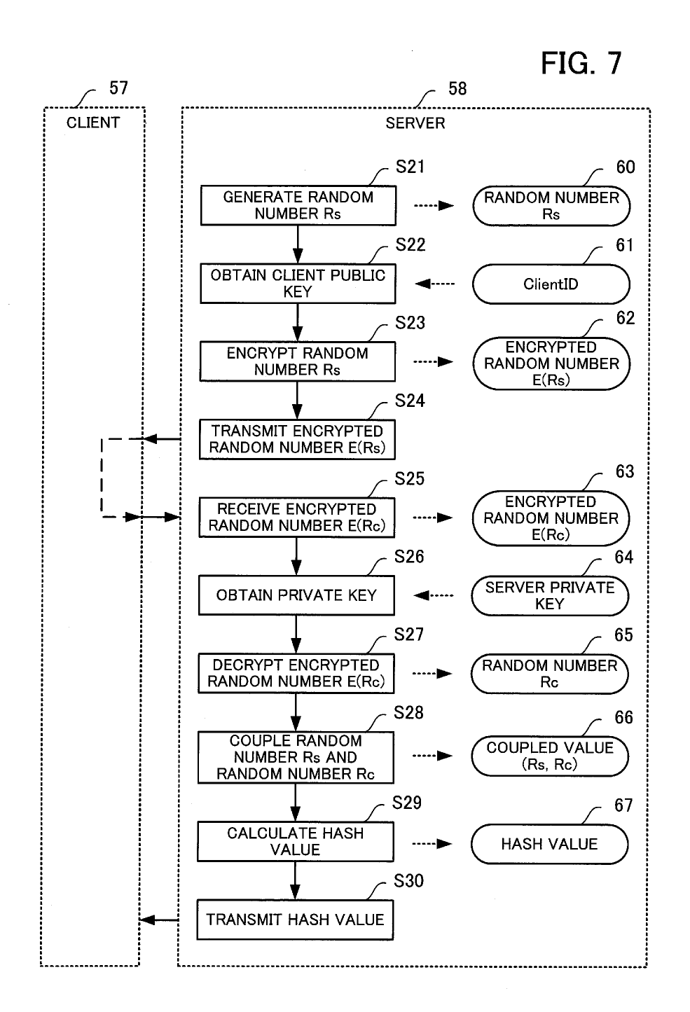

Next, each processing performed by the client 57 and server 58 is described using FIG. 7 to FIG. 9. First, the processing performed by the server side terminal apparatus in the hand shake phase is described using FIG. 7. FIG. 7 illustrates an example of the processing performed by the server side terminal apparatus in the hand shake phase of the second embodiment.

(Step S21) The server 58 generates a random number Rs 60 according to a predetermined random number generation algorithm.

(Step S22) The server 58 obtains a ClientID 61 that is an ID-based public key as the public key of the client 57. The ClientID 61 is the communication address of the client 57, for example. The ClientID 61 is information known to the server 58, and is the information retained by the storage unit 46 of the server 58, for example. Therefore, the server 58 does not need to obtain the ClientID 61 from the client 57.

(Step S23) The server 58 obtains an encrypted random number E(Rs) 62 by encrypting the random number Rs 60 using the ClientID 61.

(Step S24) The server 58 transmits the encrypted random number E(Rs) 62 to the client 57.

(Step S25) The server 58 receives an encrypted random number E(Rc) 63 from the client 57. The encrypted random number E(Rc) 63 is information that is the random number Rc encrypted with a public key of the server 58 by the client 57.

(Step S26) The server 58 obtains a server private key 64 that is the private key paired with the public key of the server 58. The server private key 64 is information known to the server 58, and is the information retained by the storage unit 46 of the server 58, for example.

(Step S27) The server 58 decrypts the encrypted random number E(Rc) 63 with the server private key 64 to obtain a random number Rc 65.

(Step S28) The server 58 generates a coupled value (Rs, Rc) 66 obtained by coupling the random number Rs 60 and the random number Rc 65. The coupled value (Rs, Rc) 66 is the information obtained by arranging the random number Rs 60 and the random number Rc 65.

(Step S29) The server 58 obtains a hash value (message digest) 67 from the coupled value (Rs, Rc) 66 by hash value calculation using a hash function. The examples of the hash function include SHA-1, MD5, and the like.

(Step S30) The server 58 transmits the hash value 67 to the client 57.

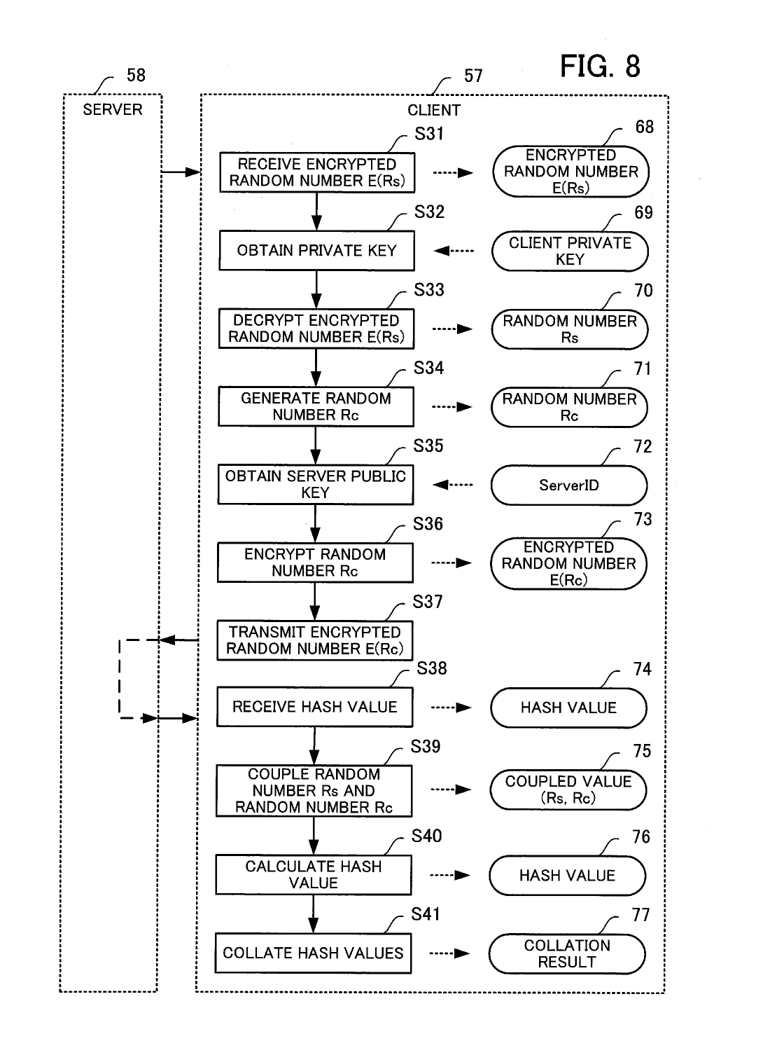

Next, the processing performed by the client side terminal apparatus in the hand shake phase is described using FIG. 8. FIG. 8 illustrates an example of the processing performed by the client side terminal apparatus in the hand shake phase of the second embodiment.

(Step S31) The client 57 receives an encrypted random number E(Rs) 68 from the server 58. Note that the encrypted random number E(Rs) 68 is equal to the encrypted random number E(Rs) 62 transmitted by the server 58 unless the encrypted random number E(Rs) 68 is illegally rewritten in the communication path.

(Step S32) The client 57 obtains a client private key 69 that is the private key paired with the public key (ClientID 61) of the client 57. The client private key 69 is information known to the client 57, and is the information retained by the storage unit 46 of the client 57, for example.

(Step S33) The client 57 decrypts the encrypted random number E(Rs) 68 with a client private key 69 to obtain a random number Rs 70.

(Step S34) The client 57 generates a random number Rc 71 according to a predetermined random number generation algorithm.

(Step S35) The client 57 obtains a ServerID 72 that is an ID-based public key as the public key of the server 58. The ServerID 72 is the communication address of the server 58, for example. The ServerID 72 is information known to the client 57, and is the information retained by the storage unit 46 of the client 57, for example. Therefore, the client 57 does not need to obtain the ServerID 72 from the server 58.

(Step S36) The client 57 obtains an encrypted random number E(Rc) 73 by encrypting the random number Rc 71 using the ServerID 72.

(Step S37) The client 57 transmits the encrypted random number E(Rc) 73 to the server 58.

(Step S38) The client 57 receives a hash value 74 from the server 58. Note that the hash value 74 is equal to the hash value 67 transmitted by the server 58 unless the hash value 74 is illegally rewritten in the communication path.

(Step S39) The client 57 generates a coupled value (Rs, Rc) 75 obtained by coupling the random number Rs 70 and the random number Rc 71, just like the server 58 generates the coupled value (Rs, Rc) 66 from the random number Rs 60 and the random number Rc 65.

(Step S40) The client 57 obtains a hash value 76 from the coupled value (Rs, Rc) 75 by hash value calculation using the same hash function as the hash function of the server 58.

(Step S41) The client 57 compares and collates the hash value 74 and the hash value 76 to obtain a collation result 77. The collation result 77 indicates the success of collation when the hash value 74 matches the hash value 76, while when the hash value 74 does not match the hash value 76, it indicates the failure of collation. The client 57 establishes a session with the server 58 because of the success of collation.

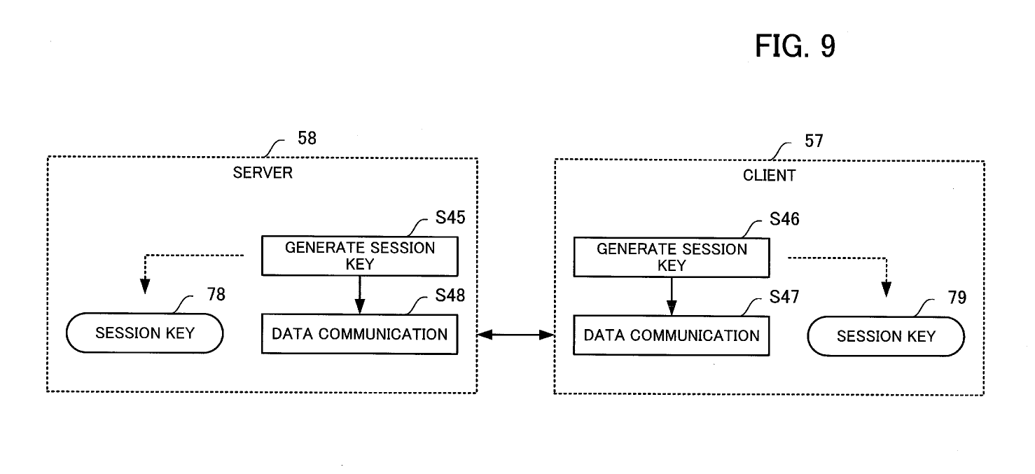

Next, the processing performed by the server side terminal apparatus and the processing performed by the client side terminal apparatus in the data transfer phase are described using FIG. 9. FIG. 9 illustrates an example of the processing performed by the server side terminal apparatus and the processing performed by the client side terminal apparatus in the data transfer phase of the second embodiment.

(Step S45) The server 58 generates, after executing step S30, a session key 78 according to a predetermined key generation algorithm based on the random number Rs 60 and the random number Rc 65.

(Step S46) The client 57 generates, after successfully collating the hash value in step S41, a session key 79 according to the same key generation algorithm as the key generation algorithm of the server 58 based on the random number Rs 70 and the random number Rc 71.

The client 57 and server 58 perform data communication that is protected using the session key 78 (session key 79) (step S47 and step S48). The server 58 is authenticated by confirming that the server 58 is able to perform normal data communication with the client 57.

In this manner, the key sharing communication performed by the client 57 and server 58 eliminates the need to send a certificate from the client 57 to the server 58, thereby realizing three-way hand shake. Moreover, in the key sharing communication performed by the client 57 and server 58, the public key encryption processing count is “4”, which is sufficiently small as compared with other conventional methods, and the number of pieces of public key encrypted data is “2”, which is sufficiently small as compared with other conventional methods. Moreover, the key sharing communication performed by the client 57 and server 58 may reduce the network load and processing load in the key sharing communication while it does not have the risk of class break and further achieves PFS.

### Third Embodiment

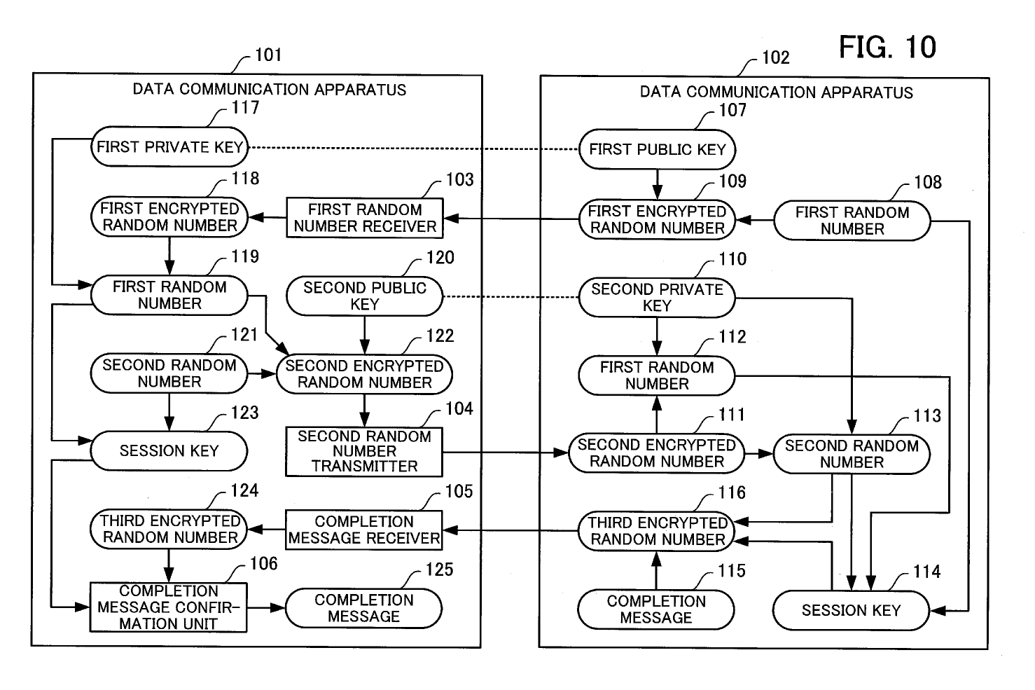

Next, the data communication method in the data communication apparatus of the third embodiment is described using FIG. 10. FIG. 10 illustrates an example of the data communication method in the data communication apparatus of the third embodiment.

The third embodiment is a TLS-type hand shake protocol based on the key sharing communication method of the first embodiment.

A data communication apparatus 101 and a data communication apparatus 102 are communicatively connected by wire or wireless to mutually perform data communication. The data communication apparatus 101 and the data communication apparatus 102 may be directly connected, or may be multi-hop connected via one or two or more relay apparatuses. The data communication apparatus 102 is another data communication apparatus for the data communication apparatus 101, and the data communication apparatus 101 is another data communication apparatus for the data communication apparatus 102.

The data communication apparatus 101 includes a first random number receiver 103, a second random number transmitter 104, a completion message receiver 105, and a completion message confirmation unit 106. The first random number receiver 103 receives a first encrypted random number 118 from the data communication apparatus 102. Note that the first encrypted random number 118 is equal to a first encrypted random number 109 transmitted by the data communication apparatus 102 unless the first encrypted random number 118 is illegally rewritten in the communication path. The data communication apparatus 102 generates a first random number 108, encrypts the first random number 108 into the first encrypted random number 109 using a first public key 107, and transmits the first encrypted random number 109 to the data communication apparatus 101 (corresponding to a non-illustrated first random number transmitter).

The second random number transmitter 104 decrypts a first random number 119 from the first encrypted random number 118 using a first private key 117. The second random number transmitter 104 generates a second random number 121. The second random number transmitter 104 encrypts the first random number 119 and second random number 121 into a second encrypted random number 122 using a second public key 120. The second random number transmitter 104 transmits the second encrypted random number 122 to the data communication apparatus 102. Note that the second encrypted random number 111 is equal to the second encrypted random number 122 transmitted by the data communication apparatus 101 unless the second encrypted random number 111 is illegally rewritten in the communication path. The data communication apparatus 102 receives the second encrypted random number 111 (corresponding to a non-illustrated second random number receiver). The data communication apparatus 102 decrypts the first random number 112 and second random number 113 using a second private key 110 paired with the second public key 120. The data communication apparatus 102 compares the first random number 108 with the first random number 112. The data communication apparatus 102 generates a session key 114 from the first random number 108 and the second random number 113 when the first random number 108 and the first random number 112 match. The data communication apparatus 102 encrypts a completion message 115 using the session key 114 to obtain a third encrypted random number 116. Note that the completion message 115 is a message used when the data communication apparatus 102 notifies the data communication apparatus 101 of the completion of establishing a session. The data communication apparatus 102 transmits the third encrypted random number 116 to the data communication apparatus 101 (corresponding to a non-illustrated completion message transmitter).

The completion message receiver 105 receives a third encrypted random number 124 from the data communication apparatus 102. Note that the third encrypted random number 124 is equal to the third encrypted random number 116 transmitted by the data communication apparatus 102 unless the third encrypted random number 124 is illegally rewritten in the communication path.

The completion message confirmation unit 106 generates a session key 123 from the first random number 119 and the second random number 121. The completion message confirmation unit 106 decrypts the third encrypted random number 124 using the session key 123 to obtain a completion message 125. The completion message confirmation unit 106 confirms the establishment of a session in which the session key is shared with the data communication apparatus 102, by properly decrypting the completion message 125.

In this manner, the data communication apparatus 101 may retain the session key 123 common with the session key 114 retained by the data communication apparatus 102. In such key sharing communication, the data communication apparatus 101 and the data communication apparatus 102 achieve three times of communication (three-way hand shake). Moreover, since the data communication apparatus 101 receives the first encrypted random number 118 in the first communication and transmits the second encrypted random number 122 in the second communication, the number of pieces of public key encrypted data in three times of communication is “2”. Moreover, the number of times of public key encryption processing is “2” in each of the data communication apparatus 101 and the data communication apparatus 102, and is totally “4” in the data communication apparatus 101 and the data communication apparatus 102. Moreover, in such key sharing communication, the data communication apparatus 101 does not have the risk of class break and achieves PFS. That is, in the method of communicating with the data communication apparatus 102, the data communication apparatus 101 may reduce the network load and processing load in the key sharing communication.

Accordingly, the key sharing communication method of the third embodiment has the performance similar to the key sharing communication methods of the first embodiment and second embodiment.

Moreover, the key sharing communication method of the third embodiment is suitable for a mesh network, in which the terminal apparatus 40 is requested to realize both functions of the client 57 and server 58, because the client 57 and the server 58 perform the same type of processing.

### Fourth Embodiment

Next, the fourth embodiment is described in which the key sharing communication method of the third embodiment is applied to a sensor network. The configuration of the sensor network 30, the functional configuration of the terminal apparatus 40, and the hardware configuration are the same as the second embodiment and therefore the description thereof is omitted. Moreover, the same configuration as the second embodiment is given the same reference numeral and the description thereof is omitted.

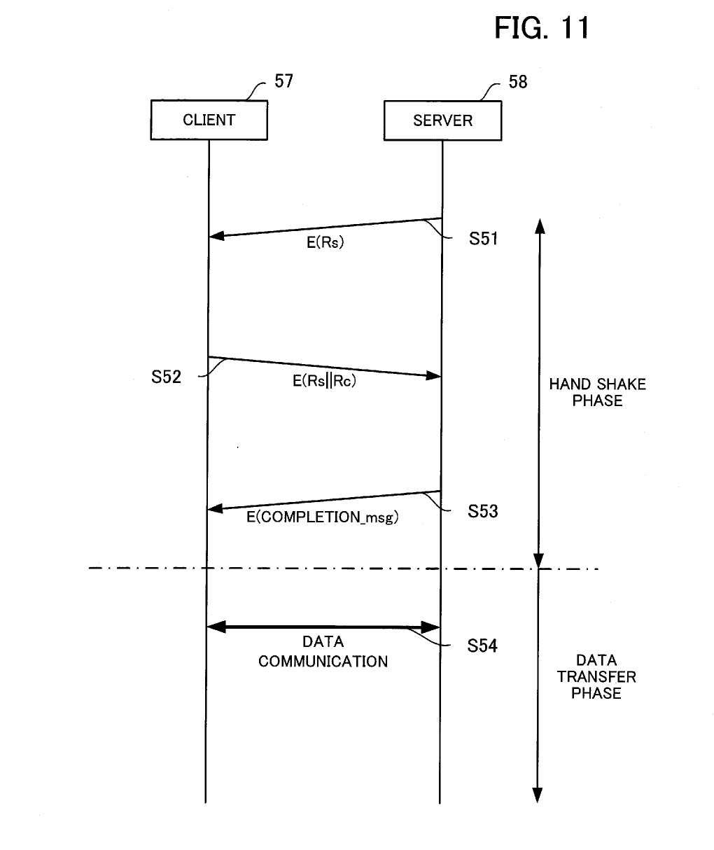

First, the key sharing communication sequence between the server side terminal apparatus and client side terminal apparatus of the fourth embodiment is described using FIG. 11. FIG. 11 illustrates an example of the key sharing communication sequence between the server side terminal apparatus and client side terminal apparatus of the fourth embodiment.

In the key sharing communication sequence between the server side terminal apparatus and the client side terminal apparatus of the fourth embodiment, the server 58 starts communication as with the second embodiment because the client 57 does not need to send a certificate to the server 58.

(Step S51) The server 58 transmits to the client 57 an encrypted random number E(Rs) obtained by encrypting a random number Rs with an ID-based public key of the client 57. The random number Rs is a random number generated by the server 58.

(Step S52) The client 57 transmits to the server an encrypted random number E(Rs∥Rc) obtained by encrypting a coupled value (Rs∥Rc) of the random number Rc and random number Rs with the ID-based public key of the server 58. The random number Rc is a random number generated by the client 57.

(Step S53) The server 58 decrypts the encrypted random number E(Rs∥Rc) with the private key of the server 58, and generates a session key from the random number Rc and random number Rs extracted from the decrypted coupled value (Rs∥Rc). The server 58 transmits to the client 57 an encrypted message E (completion_msg) that is obtained by encrypting the completion message using the session key.

The client 57 generates a session key from the random number Rc and the random number Rs and decrypts the encrypted message E (completion_msg) with the session key. The client 57 confirms the establishment of a session in which the session key is shared with the server 58, by properly decrypting the completion message.

The above-described step S51 to step S53 correspond to the hand shake phase including three times of key sharing communication. Hereinafter, the client 57 and the server 58 perform data communication using a session key generated from the random number Rc and a session key generated from the random number Rs, respectively (step S54). The step S54 and thereafter correspond to the data transfer phase in which the protected data communication is possible.

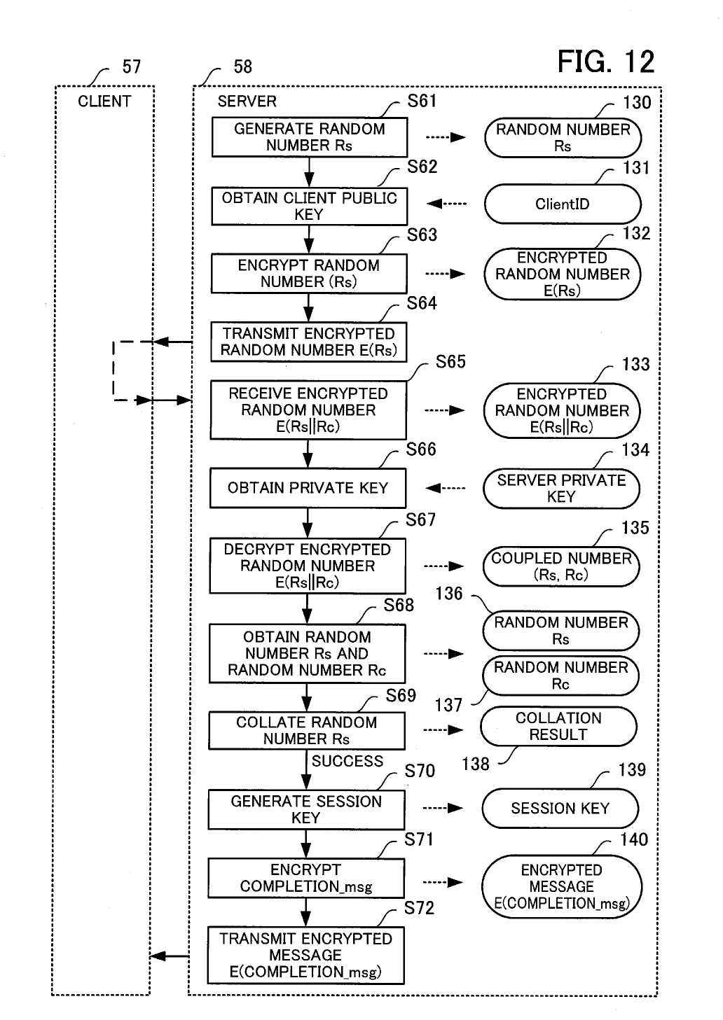

Next, each processing performed by the client 57 and server 58 is described using FIG. 12 to FIG. 14. First, the processing performed by the server side terminal apparatus in the hand shake phase is described using FIG. 12. FIG. 12 illustrates an example of the processing performed by the server side terminal apparatus in the hand shake phase of the fourth embodiment.

(Step S61) The server 58 generates a random number Rs 130 according to a predetermined random number generation algorithm.

(Step S62) The server 58 obtains a ClientID 131 that is the ID-based public key as the public key of the client 57. The ClientID 131 is the communication address of the client 57, for example. The ClientID 131 is information known to the server 58, and is the information retained by the storage unit 46 of the server 58, for example. Therefore, the server 58 does not need to obtain the ClientID 131 from the client 57.

(Step S63) The server 58 encrypts the random number Rs 130 using the ClientID 131 to obtain encrypted random number E(Rs) 132.

(Step S64) The server 58 transmits the encrypted random number E(Rs) 132 to the client 57.

(Step S65) The server 58 receives an encrypted random number E(Rs∥Rc) 133 from the client 57. The encrypted random number E(Rs∥Rc) 133 is information that is obtained by encrypting a coupled value of the random number Rs and random number Rc with the public key of the server 58 by the client 57.

(Step S66) The server 58 obtains a server private key 134 that is the private key paired with the public key of the server 58. The server private key 134 is information known to the server 58, and is the information retained by the storage unit 46 of the server 58, for example.

(Step S67) The server 58 decrypts the encrypted random number E(Rs∥Rc) 133 with the server private key 134 to obtain a coupled value (Rs, Rc) 135.

(Step S68) The server 58 extracts a random number Rs 136 and a random number Rc 137 from the coupled value (Rs, Rc) 135. The coupled value (Rs, Rc) 135 is information obtained by arranging the random number Rs 136 and the random number Rc 137.

(Step S69) The server 58 collates the random number Rs 130 and the random number Rs 136 to obtain a collation result 138. When the collation result 138 indicates a failure, the server 58 determines that it has failed in establishing a session with the client 57. On the other hand, the server 58 proceeds to step S70 when the collation result 138 indicates a success.

(Step S70) The server 58 generates a session key 139 according to a predetermined key generation algorithm based on the random number Rs 130 and the random number Rc 137.

(Step S71) The server 58 encrypts the completion_msg (completion message) using the session key 139 to obtain an encrypted message E(completion_msg) 140. Note that the completion message is a message used when the server 58 notifies the client 57 of the completion of establishing a session.

(Step S72) The server 58 transmits the encrypted message E(completion_msg) 140 to the client 57.

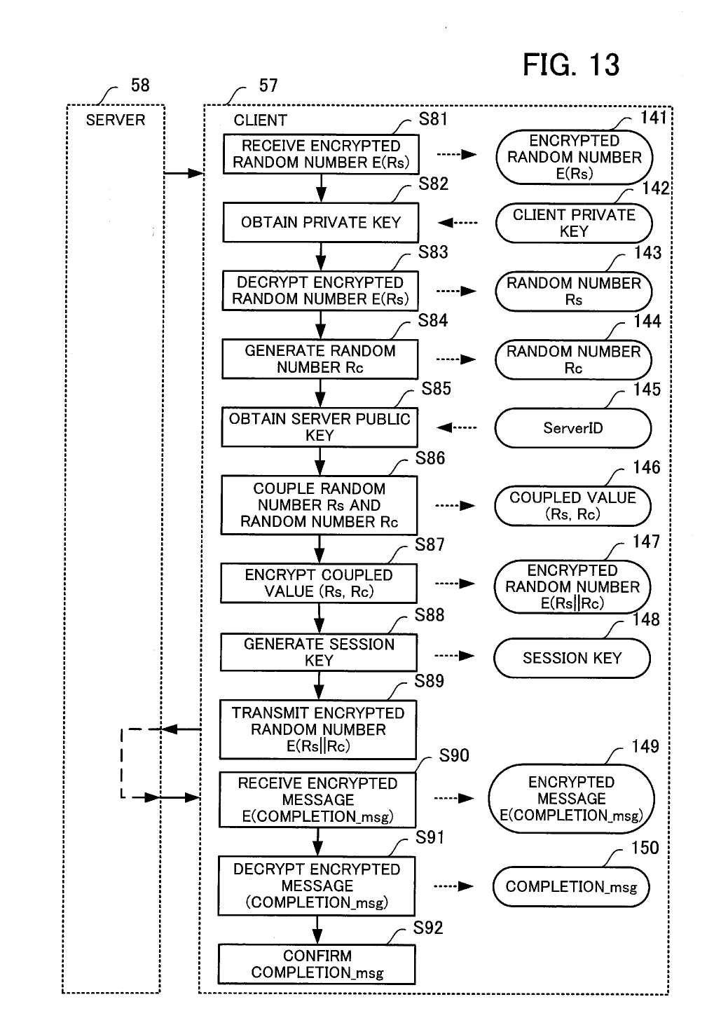

Next, the processing performed by the client side terminal apparatus in the hand shake phase is described using FIG. 13. FIG. 13 illustrates an example of the processing performed by the client side terminal apparatus in the hand shake phase of the fourth embodiment.

(Step S81) The client 57 receives an encrypted random number E(Rs) 141 from the server 58. Note that the encrypted random number E(Rs) 141 is equal to the encrypted random number E(Rs) 132 transmitted by the server 58 if the encrypted random number E(Rs) 141 is not illegally rewritten in the communication path.

(Step S82) The client 57 obtains a client private key 142 that is the private key paired with the public key (ClientID 131) of the client 57. The client private key 142 is information known to the client 57, and is the information retained by the storage unit 46 of the client 57, for example.

(Step S83) The client 57 decrypts the encrypted random number E(Rs) 141 with the client private key 142 to obtain a random number Rs 143.

(Step S84) The client 57 generates a random number Rc 144 according to a predetermined random number generation algorithm.

(Step S85) The client 57 obtains a ServerID 145 that is an ID-based public key as the public key of the server 58. The ServerID 145 is the communication address of the server 58, for example. The ServerID 145 is information known to the client 57, and is the information retained by the storage unit 46 of the client 57, for example. Therefore, the client 57 does not need to obtain the ServerID 145 from the server 58.

(Step S86) The client 57 couples the random number Rs 143 and the random number Rc 144 to generate a coupled value (Rs, Rc) 146.

(Step S87) The client 57 encrypts the coupled value (Rs, Rc) 146 using the ServerID 145 to obtain encrypted random number E(Rs∥Rc) 147.

(Step S88) The client 57 generates a session key 148 according to the same key generation algorithm as the key generation algorithm of the server 58 based on the random number Rs 143 and the random number Rc 144.

(Step S89) The client 57 transmits the encrypted random number E(Rs∥Rc) 147 to the server 58.

(Step S90) The client 57 receives an encrypted message E(completion_msg) 149 from the server 58. Note that the encrypted message E(completion_msg) 149 is equal to the encrypted message E(completion_msg) 140 transmitted by the server 58 unless the encrypted message E(completion_msg) 149 is illegally rewritten in the communication path.

(Step S91) The client 57 decrypts the encrypted message E(completion_msg) 149 with the session key 148 to obtain a completion_msg 150.

(Step S92) The client 57 confirms the establishment of a session in which the session key is shared with the server 58, by properly decrypting the completion_msg 150.

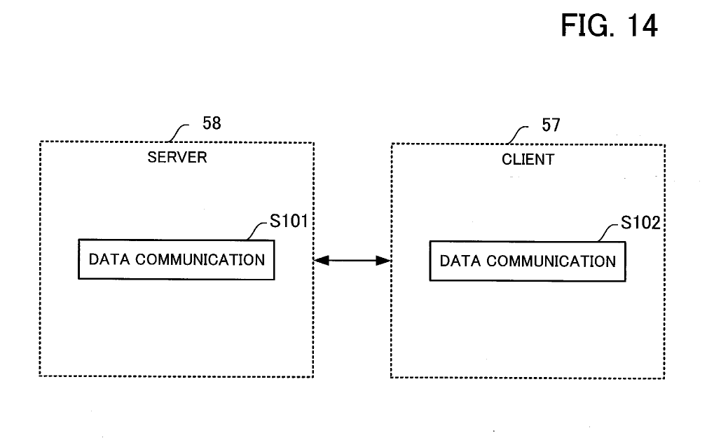

Next, the processing performed by the server side terminal apparatus and the processing performed by the client side terminal apparatus in the data transfer phase are described using FIG. 14. FIG. 14 illustrates an example of the processing performed by the server side terminal apparatus and the processing performed by the client side terminal apparatus in the data transfer phase of the fourth embodiment.

The client 57 and the server 58 perform data communication that is protected using the session key 148 (session key 139) (step S101 and step S102). The server 58 is authenticated by confirming that the server 58 is able to perform normal data communication with the client 57.

In this manner, the key sharing communication performed by the client 57 and server 58 eliminates the need to send a certificate from the client 57 to the server 58, thereby realizing three-way hand shake. Moreover, in the key sharing communication performed by the client 57 and the server 58, the public key encryption processing count is “4”, which is sufficiently small as compared with other conventional methods, and the number of pieces of public key encrypted data is “2”, which is sufficiently small as compared with other conventional methods. Moreover, the key sharing communication performed by the client 57 and server 58 may reduce the network load and processing load in the key sharing communication while it does not have the risk of class break and further achieves PFS.

### Fifth Embodiment

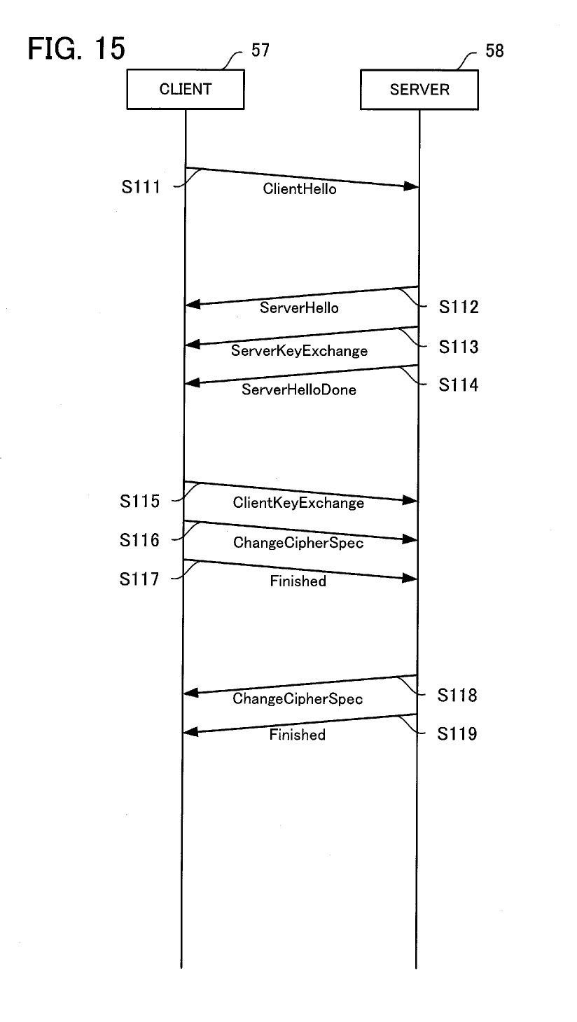

Next, the key sharing communication method of the fifth embodiment is described using FIG. 15, in which the key sharing communication method of the fourth embodiment is applied to the TLS-type hand shake protocol. FIG. 15 illustrates an example of the key sharing communication between a server side terminal apparatus and a client side terminal apparatus of the fifth embodiment.

One of the two terminal apparatuses 40 is a client (client side terminal apparatus) 57 and the other one is a server (server side terminal apparatus) 58.

(Step S111) The client 57 transmits a ClientHello message to the server 58. Note that, in this case, a certificate does not need to be sent and the ClientHello message is for the purpose of formally conforming to the TLS-type hand shake protocol, so sending the ClientHello message is not counted into the number of times of key sharing communication.

(Step S112) The server 58 transmits the ServerHello message to the client 57.

(Step S113) The server 58 transmits a ServerKeyExchange message to the client 57. The server 58 may cause the ServerKeyExchange message to include the encrypted random number E(Rs) 132 described in the fourth embodiment.

(Step S114) The server 58 transmits a ServerHelloDone message to the client 57. Note that the ServerHello message in this step S112 to the ServerHelloDone message in step S114 may be regarded as a series of messages, which is therefore counted as one (the first) key sharing communication.

(Step S115) The client 57 transmits the ClientKeyExchange message to the server 58. The client 57 may cause the ClientKeyExchange message to include the encrypted random number E(RsIIRc) 147 described in the fourth embodiment.

(Step S116) The client 57 transmits a ChangeCipherSpec message to the server 58.

(Step S117) The client 57 transmits a Finished_message to the server 58. Note that the ClientKeyExchange message in this step S115 to the Finished_message in step S117 may be regarded as a series of messages, which is therefore counted as one (the second) key sharing communication.

(Step S118) The server 58 transmits a ChangeCipherSpec message to the client 57. The client 57 may cause the ChangeCipherSpec message to include the encrypted message E(completion_msg) 140 described in the fourth embodiment.

(Step S119) The server 58 transmits the Finished_message to the client 57. Note that the ChangeCipherSpec message in this step S118 to the Finished_message in step S119 may be regarded as a series of messages, which is therefore counted as one (the third) key sharing communication.

In this manner, with the key sharing communication method of the fifth embodiment, three-way hand shake conforming to the TLS-type hand shake protocol may be realized.

Note that the above-described processing functions may be implemented on a computer. In that case, the processing contents of the functions of the data communication apparatuses 1, 2, 101, and 102 and the terminal apparatus 40 are encoded and provided in the form of computer programs. A computer system executes those programs, thereby providing the above-described processing functions. The programs may be stored in computer-readable media. Such computer-readable media include magnetic storage devices, optical discs, magneto-optical storage media, semiconductor memory devices, and other non-transitory storage media. The examples of the magnetic storage include a hard disk drive unit (HDD), a flexible disk (FD), and a magnetic tape. The examples of the optical disc include a DVD, a DVD-RAM, a CD-ROM/RW, and the like. The examples of the magneto-optical recording medium include an MO (Magneto-Optical disk).

For the purpose of distributing computer programs, for example, portable storage media such as the DVD and CD-ROM in which the program is stored are made available for sale. Moreover, network-based distribution of software programs may also be possible, in which case program files are stored in a storage device of a server computer for downloading to other computers via a network.

A computer installs programs in its local storage device, from a portable storage medium or a server computer, so that they may be executed. The computer executes the installed programs while reading them out of the own storage device, thereby performing the programmed functions. Where appropriate, the computer may execute programs directly from a portable storage medium, without installation. Another alternative method is that the computer executes programs as they are downloaded from a server computer connected via a network.

Moreover, at least a part of the above-described processing functions may be implemented on an electronic circuit, such as a DSP, an ASIC, or a PLD.

According to an aspect of the embodiments disclosed herein, in the data communication method and the data communication device, the network load and/or processing load in key sharing communication may be reduced.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A data communication method comprising:
receiving, from another data communication apparatus, a first encrypted random number obtained by encrypting a first random number with a first public key and decrypting the first encrypted random number with a first private key;
generating a second random number and transmitting, to said another data communication apparatus, a second encrypted random number obtained by encrypting the second random number with a second public key;
receiving, from said another data communication apparatus, a first hash value that is generated from the first random number and the second random number decrypted with a second private key, and comparing a second hash value, which is generated from the first random number decrypted with the first private key and the generated second random number, with the first hash value; and
when the second hash value is equal to the first hash value, generating a session key based on the first random number and the second random number.

2. The data communication method according to claim 1, wherein the first public key is identification information of said another data communication apparatus, and the second public key is identification information of the data communication apparatus.

3. The data communication method according to claim 2,
wherein the data communication apparatus retains the first public key in advance in a storage unit of the data communication apparatus, and
wherein said another data communication apparatus retains the second public key in advance in a storage unit of said another data communication apparatus.

4. A data communication apparatus comprising:
a first random number receiver configured to receive, from another data communication apparatus, a first encrypted random number obtained by encrypting a first random number with a first public key;
a second random number transmitter configured to decrypt the first encrypted random number with a first private key, generate a second random number, and transmit, to said another data communication apparatus, a second encrypted random number obtained by encrypting the second random number with a second public key;
a hash value receiver configured to receive a first hash value, which is generated from the first random number and the second random number decrypted with a second private key, from said another data communication apparatus; and
a session key generator configured to compare a second hash value, which is generated from the first random number decrypted with the first private key and the generated second random number, with the first hash value, and further generate a session key based on the first random number and the second random number when the second hash value is equal to the first hash value.

5. A data communication method between a first data communication apparatus and a second data communication apparatus, the method comprising:
generating, by the first data communication apparatus, a first random number and transmitting, to the second data communication apparatus, a first encrypted random number obtained by encrypting the first random number with a first public key;
decrypting, by the second data communication apparatus, the first encrypted random number received from the first data communication apparatus with a first private key to obtain the first random number, generating a second random number, and transmitting, to the first data communication apparatus, a second encrypted random number obtained by encrypting the second random number with a second public key;
decrypting, by the first data communication apparatus, the second encrypted random number received from the second data communication apparatus with a second private key to obtain the second random number, generating a first hash value from the generated first random number and the decrypted second random number, and transmitting the first hash value to the second data communication apparatus; and
comparing, by the second data communication apparatus, a second hash value, which is generated from the generated second random number and the decrypted first random number, with the first hash value, and generating a session key based on the first random number and the second random number when the second hash value is equal to the first hash value.

6. A data communication method comprising:
receiving, from another data communication apparatus, a first encrypted random number obtained by encrypting a first random number with a first public key and decrypting the first encrypted random number with a first private key;
generating a second random number, and transmitting, to said another data communication apparatus, a second encrypted random number obtained by encrypting the second random number and the decrypted first random number with a second public key;
receiving, when the first random number generated by said another data communication apparatus is equal to the decrypted first random number, receiving a completion message encrypted with a session key that is generated from the first random number and the second random number; and
generating the session key from the decrypted first random number and the generated second random number, decrypting a completion message encrypted with the received session key with the session key, and confirming sharing of the session key with said another data communication apparatus.

7. The data communication method according to claim 6, wherein the first public key is identification information of said another data communication apparatus, and the second public key is identification information of the data communication apparatus.

8. The data communication method according to claim 7, further comprising:
retaining, by the data communication apparatus, the first public key in advance in a storage unit of the data communication apparatus, and
retaining, by said another data communication apparatus, the second public key in advance in a storage unit of said another data communication apparatus.

9. A data communication apparatus comprising:
a first random number receiver configured to receive, from another data communication apparatus, a first encrypted random number obtained by encrypting a first random number with a first public key;
a second random number transmitter configured to decrypt the first encrypted random number with a first private key, generate a second random number, and transmit, to said another data communication apparatus, a second encrypted random number obtained by encrypting the second random number and the decrypted first random number with a second public key;
a completion message receiver configured to receive a completion message encrypted with a session key that is generated from the first random number and the second random number, when the first random number generated by said another data communication apparatus is equal to the decrypted first random number; and
a completion message confirmation unit configured to generate the session key from the decrypted first random number and the generated second random number, decrypt the received completion message, which is encrypted with the session key, with the session key, and confirm sharing of the session key with said another data communication apparatus.

10. A data communication method between a first data communication apparatus and a second data communication apparatus, the method comprising:
generating, by the first data communication apparatus, a first random number and transmitting, to the second data communication apparatus, a first encrypted random number obtained by encrypting the first random number with a first public key;
decrypting, by the second data communication apparatus, the first random number with a first private key from the first encrypted random number received from the first data communication apparatus, generating a second random number, and transmitting, to the first data communication apparatus, a second encrypted random number obtained by encrypting the first random number and the second random number with a second public key;
decrypting, by the first data communication apparatus, the first random number and the second random number with a second private key from the second encrypted random number received from the second data communication apparatus, generating a session key from the first random number and the second random number when the generated first random number is equal to the decrypted first random number, and transmitting, to the second data communication apparatus, a third encrypted random number obtained by encrypting a completion message with the session key; and
generating, by the second data communication apparatus, the session key from the decrypted first random number and the generated second random number, decrypting the received third encrypted random number with the session key, and confirming sharing of the session key with the first data communication apparatus.
